(19) United States
(12) Patent Application Publication
(10) Pub. No.: US 2010/0128688 A1
(43) Pub. Date: May 27, 2010

(54) DATA TRANSMISSION/RECEPTION METHOD IN WIRELESS COMMUNICATION SYSTEM, AND DATA TRANSMITTER AND DATA RECEIVER USING THE SAME

(75) Inventors: Yoo-Seung Song, Daejeon (KR); Jeeyon Choi, Daejeon (KR); Yun-Joo Kim, Gyeonggi-do (KR); Hyun-Gu Park, Seoul (KR); Sok-kyu Lee, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejon (KR)

(21) Appl. No.: 12/623,848

(22) Filed: Nov. 23, 2009

(30) Foreign Application Priority Data
Nov. 24, 2008 (KR) 10-2008-0116917

(51) Int. Cl. H04W 72/12

(52) U.S. Cl. 370/329

(57) ABSTRACT

A data transmission method includes: deciding the priority of data; deciding a channel priority based on a channel state; selecting a modulation and coding scheme (MCS) for the data based on the priority of data; selecting a transmission channel through which the data is to be transmitted, based on the channel priority; and modulating and coding the data in accordance with the selected MCS, and transmitting the modulated and coded data through the selected transmission channel.

### CROSS-REFERENCE(S) TO RELATED APPLICATIONS

The present application claims priority of Korean Patent Application No(s). 10-2008-0116917, filed on Nov. 24, 2008, which is incorporated herein by reference in its entirety.

### BACKGROUND OF THE INVENTION

1. Field of the Invention

Exemplary embodiments of the present invention relates to a wireless communication system; and, more particularly, to a data transmission/reception method in a wireless communication system, and a data transmitter and a data receiver using the same.

2. Description of Related Art

A wireless communication system allocates resources when transmitting data. A resource allocation scheduler of a conventional wireless communication system simply uses one modulation scheme selected for each user terminal. That is, when various types of data are transmitted to one user terminal through physical frames, the same modulation scheme is collectively used. In this case, while a data reception success rate may increase, characteristics according to types of the transmitted data are not reflected. For example, permissible transmission error rates may differ based on the types of data. When the same modulation scheme is collectively used, the wireless communication system selects a modulation scheme, based on data which should be transmitted most stably. In this case, if an excessively low modulation scheme is applied based on data, a data transmission rate may be reduced. As a result, the overall transmission rate of the system may be reduced.

A conventional wireless communication system using multiple antennas collectively transmits data, without selection of a transmit antenna. In general, a multi-antenna system has a different wireless channel state for each antenna. Therefore, when data is transmitted in consideration of the channel state of each antenna, a data transmission rate may increase, or an error rate may decrease. However, when a transmit antenna is not selected like in the conventional system, characteristics according to antennas are not reflected. Hence, the efficiency of the data transmission may be degraded.

### SUMMARY OF THE INVENTION

An embodiment of the present invention is directed to a wireless communication system which is capable of increasing the efficiency of resource utilization based on channel states, upon transmission and reception of data.

Another embodiment of the present invention is directed to a data transmission/reception method, and a data transmitter and a data receiver using the same, which are capable of ensuring data transmission/reception quality in a wireless communication system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a data transmission method includes: deciding a priority of data; deciding a channel priority based on a channel state; selecting a modulation and coding scheme (MCS) for the data based on the priority of data; selecting a transmission channel through which the data is to be transmitted, based on the channel priority; and modulating and coding the data in accordance with the selected MCS, and transmitting the modulated and coded data through the selected transmission channel.

In accordance with another embodiment of the present invention, a data transmitter includes: a priority decision unit configured to decide a priority of data; an MCS selection unit configured to select an MCS for the data, based on the priority of data; a channel priority decision unit configured to decide a channel priority, based on a channel state; a channel selection unit configured to select a transmission channel through which the data is to be transmitted, based on the channel priority; and a data transmission unit configured to modulate and code the data in accordance with the selected MCS, and transmit the modulated and coded data through the selected transmission channel.

In accordance with another embodiment of the present invention, a data reception method includes: transmitting state information of channels; receiving data through a channel selected based on a priority of data and the state information; and demodulating and decoding the data through a demodulating and decoding scheme corresponding to an MCS selected based on the priority of data and the state information.

In accordance with another embodiment of the present invention, a data receiver includes: a transmission unit configured to transmit state information of channels; a reception unit configured to receive data through a channel selected based on the priority of data and the state information; and a demodulation and decoding unit configured to demodulate and decode the data through a demodulating and decoding scheme corresponding to an MCS selected based on the priority of data and the state information.

### BRIEF DESCRIPTION OF THE DRAWINGS

FIG. 1 is a flowchart of a data transmission method in accordance with an embodiment of the present invention.

FIG. 2 is a configuration diagram of a data transmitter in accordance with another embodiment of the present invention.

FIG. 3 is a configuration diagram of a data transmitter in accordance with another embodiment of the present invention.

FIG. 4 is a detailed configuration diagram of a queue control block of FIG. 3.

FIG. 5 is a detailed configuration diagram of a transmission scheduler block of FIG. 3.

FIG. 6 illustrates a transmission frame in accordance with an embodiment of the present invention.

FIG. 7 illustrates a transmission frame in accordance with another embodiment of the present invention.

FIG. 8 is a flowchart illustrating a process of selecting a data modulation and coding scheme (MCS) in accordance with an embodiment of the present invention.

FIG. 9 is a flowchart of a data reception method in accordance with an embodiment of the present invention.

FIG. 10 is a configuration diagram of a data receiver in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention. The drawings are not necessarily to scale and in some instances, proportions may have been exaggerated in order to clearly illustrate features of the embodiments.

<Data Transmission Method>

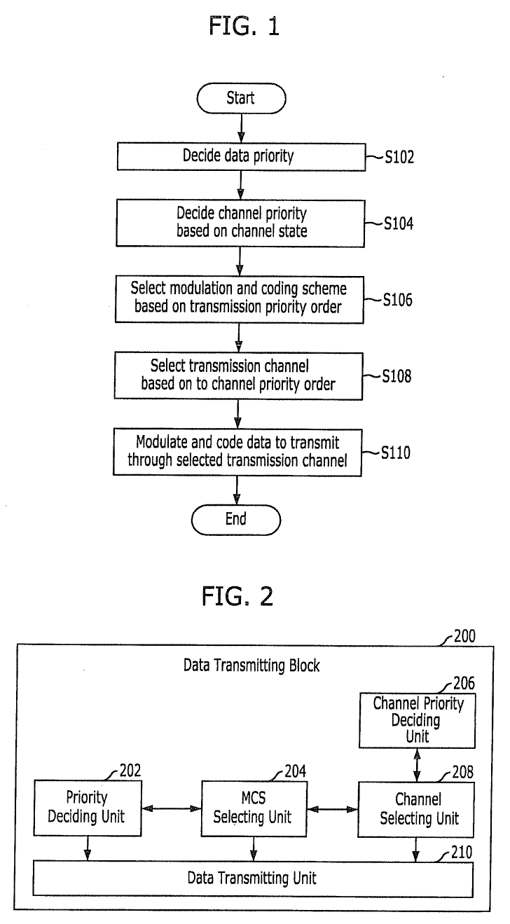

FIG. 1 is a flowchart of a data transmission method in accordance with an embodiment of the present invention. Referring to FIG. 1, the data mission method according to the embodiment of the present invention includes a priority decision step S102, a channel priority decision step S104, a modulation and coding scheme (MCS) selection step S106, a transmission channel selection step S108, and a data transmission step S110. For convenience's sake, the following description will be made based on a case where the data transmission method is performed by a data transmitter.

First, the data transmitter decides the priority of data to be transmitted at the priority decision step S102. At the priority decision step S102, the priority of the data may be decided differently based on types of the data. The priority decision criteria may include a transmission quality required for data, the importance of data, the transmission sequence of data, and so on. The data transmitter decides channel priorities based on channel states at the channel priority decision step S104.

The data transmitter selects an MCS for the data at the MCS selection step S106, based on the priority decided at the priority decision step S102, and selects a channel through which the data is to be transmitted at the transmission channel selection step S108, based on the channel priority decided at the channel priority decision step S104. The data transmitter modulates and codes the data in accordance with the selected MCS, and transmits the modulated and coded data through the selected channel at the data transmission step S110.

The sequence of the priority decision step S102, the channel priority decision step S104, the MCS selection step S106, and the transmission channel selection step S108 is not limited to that illustrated in FIG. 1.

At the priority decision step S102, the priority of common data which are commonly transmitted to a plurality of terminals may be decided to be the highest, and the priorities of control information and data retransmitted due to a transmission failure may be decided to be higher than those of other general data. In this case, MCSs are selected in a stable order, depending on the decided priorities at the MCS selection step S106.

When the data transmitter uses multiple antennas, the priorities of the antennas may be decided depending on channels states of the multiple antennas at the channel priority decision step S104. In this case, at the transmission channel selection step S108, an antenna through which data is to be transmitted is selected depending on the decided priorities of the antennas.

At the channel priority decision step S104, information on a data reception success rate of a terminal is received from the terminal, and the channel priority may be decided depending on the data reception success rate. In this case, at the MCS selection step S106, an MCS for the data may be selected depending on the priority decided at the priority decision step S102 and the channel priority decided at the channel priority decision step S104. Furthermore, at the transmission channel selection step S108, a channel through which the data is to be transmitted may be selected depending on the priority decided at the priority decision step S102 and the channel priority decided at the channel priority decision step S104.

At the channel priority decision step S104, data reception sensitivity may be received from a terminal, and the channel priority may be decided based on the data reception sensitivity. In this case, at the transmission channel selection step S108, a channel through which the data is to be transmitted may be selected based on the priority decided at the priority decision step S102 and the channel priority decided at the channel priority decision step S104. At this time, when the data transmitter uses multiple antennas, channels may be formed by the respective antennas.

In accordance with the above-described data transmission method, the efficiency of resource allocation may be maximized based on types of data and channel states. Furthermore, since MCSs are selected in consideration of channel states based on types of data, different transmission qualities may also be applied to various types of data transmitted to one terminal.

<Data Transmitter>

FIG. 2 is a configuration diagram of a data transmitting block 200 in accordance with another embodiment of the present invention. Referring to FIG. 2, the data transmitting block 200 includes a priority deciding unit 202, an MCS selecting unit 204, a channel priority deciding unit 206, a channel selecting unit 208, and a data transmitting unit 210.

The priority deciding unit 202 decides the priority of data to be transmitted by the data transmitting block 200. The MCS selecting unit 204 selects an MCS for the data based on the decided priority. The channel priority deciding unit 206 decides a channel priority based on a channel state. The channel selecting unit 208 selects a channel through which the data is to be transmitted, based on the decided channel priority. The data transmitting unit 210 modulates and codes the data based on the scheme selected by the MCS selecting unit 204, and transmits the modulated and coded data through the channel selected by the channel selecting unit 208.

The priority deciding unit 202 may decide priorities differently based on types of data. The decision criteria of the priority may include a transmission quality required for data, the importance of data, the transmission sequence of data, and so on. Furthermore, the priority deciding unit 202 may decide the priority of common data, which are commonly transmitted to a plurality of terminals, to be the highest and the priority of control information; and retransmitted data to be higher than those of general data. The priority deciding unit 202 may periodically update the priority of the data.

The MCS selecting unit 204 may select MCSs in a stable order, based on the priority of data. Furthermore, the MCS selecting unit 204 may select MCSs differently in accordance with the channel priority decided depending on the channel state as well as the priority of data. While managing MCSs in a table form, the MCS selecting unit 204 may periodically update the MCSs in order for rapid operation.

When the data transmitting block 200 uses multiple antennas, the channel priority deciding unit 206 may decide the priorities of the antennas, based on the channel states formed by the multiple antennas. In this case, the channel selecting unit 208 selects an antenna through which data is to be transmitted based on the priorities of the antennas.

The channel priority deciding unit 206 may decide a channel priority depending on a data reception success rate received from a terminal or data reception sensitivity to the channel received from a terminal. The channel selecting unit 208 may select a channel through which data is to be transmitted, based on the channel priorities decided based on the channel state as well as the priority of data.

<Another Embodiment of Data Transmitter<

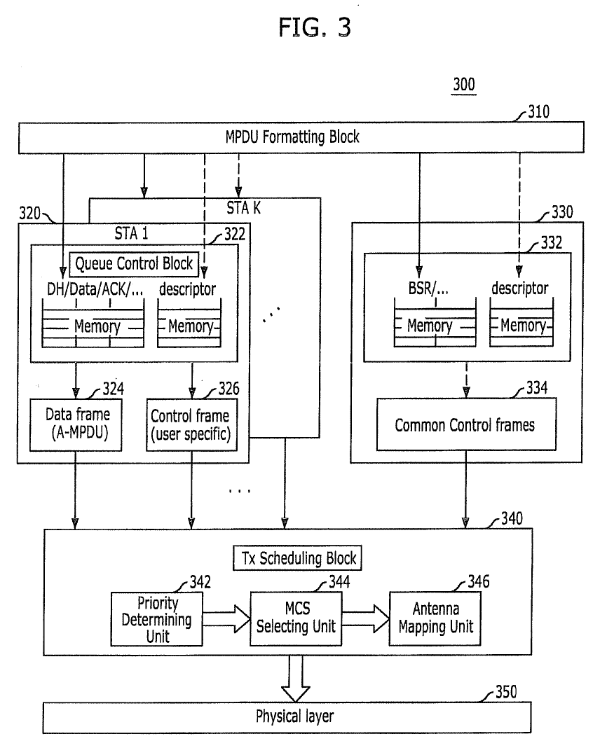

FIG. 3 is a configuration diagram of a data transmitter 300 in accordance with another embodiment of the present invention. Referring to FIG. 3, the data transmitter 300 includes a MAC Protocol Data Unit (MPDU) formatting block 310, queue control blocks 320 and 330, a transmission scheduler block 340, and a physical layer 350.

The data transmitter 300 is applied to an Orthogonal Frequency Division Multiplexing-Time Division Multiplexing Access (OFDM-TDMA) Multiple Input Multiple Output (MIMO) wireless communication system.

The MPDU formatting block 310 formats data to be transmitted into an MPDU form. The formatted MPDU is divided for each user terminal to be stored in a memory 322. Information associated with the MPDU stored in such a manner is stored in the descriptor memory 322. In FIG. 3, user terminals are indicated by reference numerals STA 1 to STA K.

The queue control block 320 forms data, which is to be transmitted to a specific user terminal, into an aggregated MPDU to format a data frame 324. The data frame 324 is a Media Access Control (MAC) frame. Furthermore, the queue control block 320 formats control information applied to each user terminal into a control frame 326 which is a MAC frame. Examples of data to be transmitted to a specific user terminal may include DH, Data, ACK, and so on. “DH” is data which is additionally transmitted in order for data to be transmitted to a specific user terminal. “Data” is data containing information which are substantially transmitted, and “ACK” is data informing whether the corresponding user terminal successfully receives the transmitted data or not.

The queue control block 330 manages a MPDU for common control information, separately from the queue control block 320. The queue control block 330 stores a MPDU for common control information in the memory 332 and information associated with the MPDU in the descriptor memory 332. The common control information stored in such a manner is formatted as a common control frame 334 which is a MAC frame. Examples of the common control information which is commonly transmitted to a plurality of user terminals may include “BSR. “BSR” is system information.

The frames 324, 325 and 445 formatted by the queue control blocks 320 and 330 are transmitted to the transmission scheduler block 340. The data frame 324 includes data to be transmitted to each user terminal, the control frame 326 includes control information on each user terminal, and the common control frame 334 includes common control information which is commonly applied to a plurality of user terminals.

The transmission scheduler block 340 receiving MAC frame data decides the priority of the data to be transmitted, maps an MCS, and maps an antenna through which the data are to be transmitted. When this process is completed, the transmission scheduler block 340 transmits the data to be transmitted or the MAC frame to the physical layer 350.

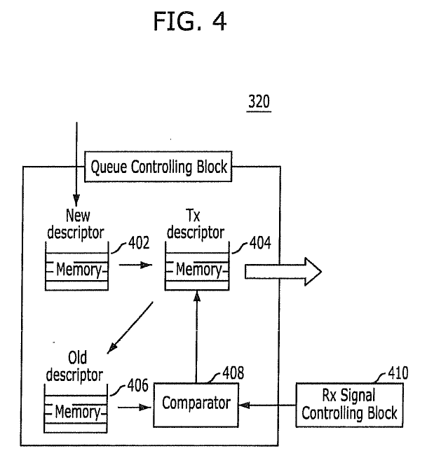

FIG. 4 is a detailed configuration diagram of the queue control block 320 of FIG. 3. Hereafter, a memory update process of the queue control block 320 will be described with reference to FIG. 4.

The queue control block 320 includes a new descriptor 402, a transmit descriptor 404, an old descriptor 406, and a comparator 408. The new descriptor 402 stores information associated with newly received data, and the transmit descriptor 406 stores information associated with data to be finally transmitted. The old descriptor 406 temporarily stores information associated with transmitted data.

When storing the data transmitted from the MPDU formatting block 310 in the memory, the queue control block 320 stores associated information as a descriptor form in the new descriptor 402. The old descriptor 406 receives associated information of previously transmitted data from the transmit descriptor 404. The old descriptor 406 transmits this associated information to the comparator 408. The comparator 408 receives information on data, which is received at a receiving end, or data, which is not received at the receiving end from a receive signal control block 410. The comparator 408 compares the old descriptor 404 with the associated information of the receive signal control block 410 to extract information associated with data which have been transmitted but are not received at the receiving end. The extracted information is transmitted to the transmit descriptor 404.

The transmit descriptor 404 combines the associated information transmitted from the new descriptor 402 and the associated information transmitted from the comparator 408 to format the associated information on data to be finally transmitted. The transmit descriptor 404 transmits the associated information of the finally-decided data to the transmission scheduler block 340. The transmit descriptor 404 transmits this associated information to the old descriptor 406, so that it is temporarily stored.

By updating the memory in such a manner, the queue control block 320 may extract data which have been transmitted but should be retransmitted due to a transmission failure, and then retransmit the extracted data.

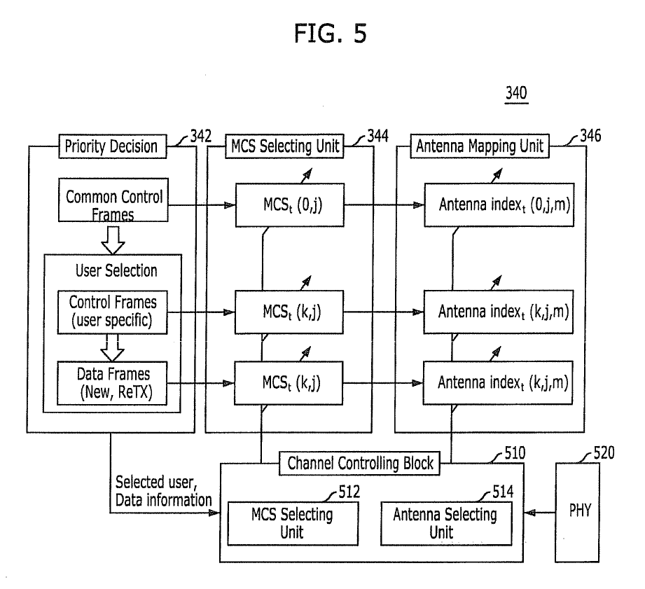

FIG. 5 is a detailed configuration diagram of the transmission scheduler block 340 of FIG. 3. Hereafter, data priority decision, MSC mapping, and antenna mapping of the transmission scheduler block 340 will be described with reference to FIG. 5. In the accompanying drawings, k, j, and m represent a user terminal, a type of data, and an index for an antenna, respectively, and parameters with a subscript t represent parameters which are updated with time.

The transmission scheduler block 340 receives a MAC frame classified for each data type from the queue control block. The priority decision block 342 provided in the transmission scheduler block 340 decides the priorities of data based on the types of the data. For example, the priority decision block 342 decides the priority of common control information to be the highest and the priority of control information to be the second highest. Furthermore, the priority decision block 342 may differentially decide the priorities of general data based on the respective user terminals.

The types of data may be divided and represented as shown in Table 1.

TABLE 1

| | |
|---|---|
| TX Data | j |
| BSR | 0 |
| BR | 1 |
| ACK | 2 |
| Re TX | 3 |
| (New) Data | 4 |
| . . . | . . . |

The types of data are represented using an index j. BSR which is common control information is represented by 0, BR is represented by 1, ACK is represented by 2, Re_TX is represented by 3, and (New) Data is represented by 4. BSR is commonly transmitted as system information to a plurality of terminals. Re_TX indicates general data which are retransmitted and (New) Data indicates general data which are newly transmitted.

The MCS mapping block 344 selects an MCS for each data. The MCS mapping block 344 uses an MCS table as shown in FIG. 2, in order for a rapid operation.

TABLE 2

| MCSt (k, j) | k = 1 | k = 2 | k = 3 |
|---|---|---|---|
| j = 0 | QPSK 1/2 | QPSK 1/2 | 16QAM 2/3 |
| j = 1 | QPSK 1/2 | 16QAM 2/3 | 16QAM 2/3 |
| j = 2 | 16QAM 2/3 | 64QAM 5/6 | QPSK 1/2 |

The MCS mapping block 344 may apply an MCS differently based on a user terminal k and a data type j, using the MCS table shown in FIG. 2. For example, when BSR (j=0), common control information, is transmitted to a user terminal (k=2), QPSK 1/2 may be used. When ACK (j=2) is transmitted to a user terminal (k=1), 160QAM 2/3 may be used. The MCS table may be periodically updated based on channel states.

An MCS selection block 512 included in the channel control block 510 manages the MCS table. The MCS table may be decided so as to satisfy a transmission error rate required based on the type of data. For example, stable MCSs may be selected in an order of common control information, control information, retransmitted data, and general data based on the priority of data. When a specific error rate Pe is required for general data, an MCS Pe corresponding to the error rate may be selected for the general data, and a more stable scheme than the MCS Pe may be selected for the control information and the retransmitted data.

Since a channel state may differ for each user terminal, the MCS selection block 512 may decide an MCS matching with an index j, considering the channel state of each user terminal. For example, the MCS selection block 512 receives a data reception success rate of each user terminal from the physical layer 520, and grasps a channel state from the data reception success rate to decide the MCS table such that a transmission error rate is satisfied based on the channel state.

The antenna mapping block 346 selects an antenna through which data is to be transmitted. In this embodiment, the data transmitter including the transmission scheduler block 340 is applied to a MIMO wireless communication system. In general, the MIMO wireless communication system secures sufficient distances among multiple antennas such that the respective antennas may operate independently. Therefore, the channel characteristics of the respective antennas may be formed differently. The antenna mapping block 346 selects an antenna suitable for data transmission among the multiple antennas, considering the channel states of the antennas based on time. The antenna mapping block 346 maps a transmit antenna in accordance with the antenna priorities decided by the antenna selection block 514 based on the priorities of the data.

The antenna selection block 514 included in the channel control block 510 decides the priorities of the antennas based on the channel states of the user terminals, the types of data, and the channel states of the antennas.

The antenna selection block 514 receives the data reception success rates of the respective user terminals and the reception sensitivity of the antennas from the physical layer 520. The antenna selection block 514 reflects the channel states through the data reception success rates and the reception sensitivity of the antennas. Table 3 shows signal to noise ratios (SNR) as examples of the reception sensitivity of the antennas.

TABLE 3

| SNR | CQI |
|---|---|
| SNR < 5 dB | 0000 |
| 5 dB ≦ SNR < 10 dB | 0001 |
| 10 dB ≦ SNR < 15 dB | 0010 |
| 15 dB ≦ SNR < 20 dB | 0011 |
| 20 dB ≦ SNR < 25 dB | 0100 |
| 25 dB ≦ SNR < 30 dB | 0101 |
| 30 dB ≦ SNR | 0110 |

As shown in Table 3, a Channel Quality Indicator (CQI) is decided based on SNR levels. The antenna selection block 514 decides an antenna priority using a CQI received from the physical layer 520.

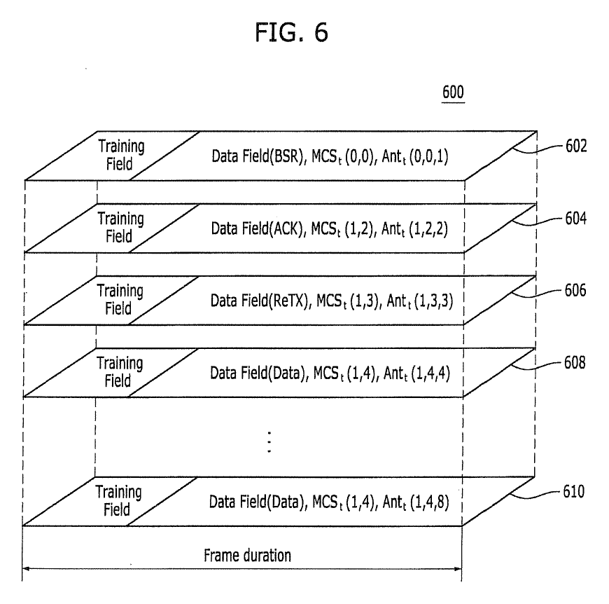

FIG. 6 illustrates a transmission frame 600 in accordance with an embodiment of the present invention. FIG. 6 illustrates a case in which one physical frame is used to transmit various types of data to one user terminal. In this embodiment, one user terminal (k=1), four types of data (j=0, 2, 3, 4), and eight antennas (m=1, 2, 3, . . . , 8) are used. When the index k representing a user terminal is 0, it indicates a case in which data are commonly transmitted to a plurality of terminals.

The transmission frame 600 includes eight frames 602 to 610 based on the transmit antennas. The frame 602 including BSR data (j=0) is commonly (k=0) transmitted to user terminals through the first antenna (m=1). Similarly, the frame 604 including ACK data (j=2) is transmitted to the user terminal (k=1) through the second antenna (m=2). The frame 606 including Re_TX data (j=3) is transmitted to the user terminal (k=1) through the third antenna m=3. The frame 608 including Data (j=4) is transmitted to the user terminal (k=1) through the fourth antenna (m=4). The frame 610 including Data (j=4) is transmitted to the user terminal (k=1) through the eighth antenna (m=8).

In each frame, an MCS is selected based on the channel state of the user terminal and the data type. Furthermore, a transmit antenna is selected based on the channel state of the user terminal, the data type, and the channel state of each antenna. The MCS is selected by mapping MCSₜ(k,j) on the MCS table, and the transmit antenna is selected by mapping Antₜ(k,j,m) in the antenna selection block. As the data are transmitted in such a manner, the MCS may be applied differently for one user terminal based on the types of data, making it possible to maximize resource efficiency.

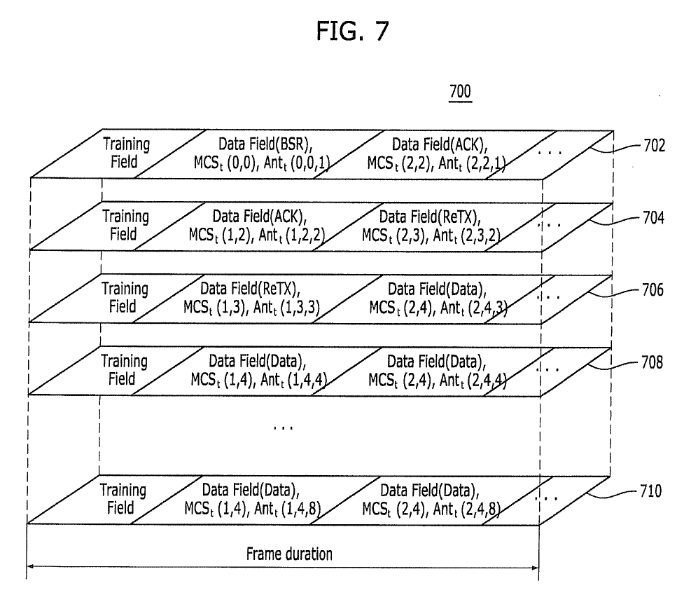

FIG. 7 illustrates a transmission frame 700 in accordance with an embodiment of the present invention. Specifically, FIG. 7 illustrates a case in which one physical frame is used to transmit various types of data to a plurality of user terminals. In this embodiment, two user terminals (k=1, 2), four data types (j=0, 2, 3, 4), and eight antennas (m=1, 2, 3, . . . , 8) are used. When the index k representing a user terminal is 0, it indicates a case in which data are commonly transmitted to a plurality of terminals.

The transmission frame 700 includes eight frames 702 to 710 based on the transmit antennas. As illustrated in FIG. 7, the respective frames 702 to 710 are formatted in accordance with the user terminals k, the data types j, and the antennas m to transmit data. For example, the frame 702 includes BSR data (j=0) which are commonly transmitted to a plurality of user terminals, and is transmitted through the first antenna (m=1). The frame 702 includes ACK data (j=2) transmitted to the second user terminal (k=2). Since data to be transmitted to the other frames 704 to 710 are illustrated in FIG. 7, its detailed description will be omitted.

In each frame, an MCS is selected based on the channel state of the user terminal and the data type. Furthermore, a transmit antenna is selected based on the channel state of the user terminal, the data type, and the channel state of each antenna. The MCS is selected by mapping MCSₜ(k,j) on the MCS table, and the transmit antenna is selected by mapping Antₜ(k,j,m) in the antenna selection block. As the data are transmitted in such a manner, it is possible to implement an optimal data transmission rate based on the data type in consideration of the channel states of each user terminal and antenna. Furthermore, in order to satisfy a transmission error rate, an excessively stable MCS may not be selected.

Since the embodiments shown in FIGS. 6 and 7 are applied to the OFDM-TDMA MIMO wireless communication system, the frames are formatted so that resources are allocated symbol by symbol. In an OFDMA wireless communication system or the like, resources may be allocated so as to be divided by time and frequency axes.

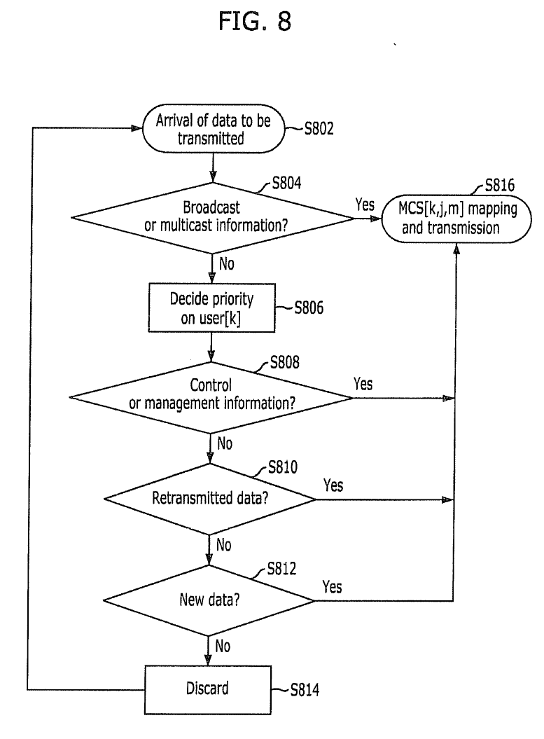

FIG. 8 is a flowchart schematically illustrating a process of selecting a MCS of data in accordance with an embodiment of the present invention. Hereafter, the process of selecting a MCS of data will be described with reference to FIG. 8.

When data to be transmitted arrives at a step S802, it is determined at a step S804 whether the data is broadcast information to be commonly transmitted, or multicast information to be individually transmitted. When it is determined that the data is broadcast information, an MCS is mapped based on the data at a step S816. When it is determined that the data is multicast information, the priority of the data is decided for each user terminal at a step S806. Then, it is sequentially determined whether the data is control information, retransmitted data, or newly transmitted data at steps S808, S810 and S812. Based on the determination result, an MCS is mapped for each data type at the step S816, and the data is finally discarded at a step S814.

<Data Reception Method>

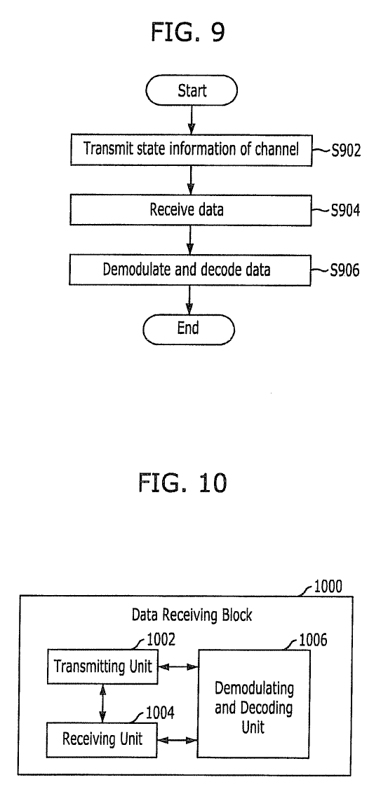

FIG. 9 is a flowchart of a data reception method in accordance with another embodiment of the present invention. Referring to FIG. 9, the data reception method includes a data reception success rate transmission step S902, a data reception step S904, and a demodulation and decoding step S906. At the data reception success rate transmission step S902, a data reception success rate is transmitted. At the data reception step S904, data is received through a channel selected based on the priority of data and the data reception success rate. At the demodulation and decoding step S906, the data is demodulated and decoded through a demodulation and decoding scheme corresponding to an MCS selected based on the priority of data and the data reception success rate. The priority of the data may be decided based on the types of the data.

At the data reception success rate transmission step S902, the data reception success rate may be transmitted to a data transmitter. The data transmitter may decide a channel through which a next data is to be transmitted, an MCS or the like based on the data reception success rate. At the data reception step S904, data transmitted through the channel selected based on the data reception success rate of the data reception success rate transmission step S902 is received. At the demodulation and decoding step S906, the data modulated and coded through the MCS selected based on the data reception success rate is demodulated and decoded through a demodulation and decoding scheme selected corresponding to the MCS. Data received by a system using multiple antennas may be data transmitted through an antenna selected based on the data reception success rate among the multiple antennas.

In the data reception method in accordance with the embodiment of the present invention, it is possible to receive data transmitted so that resource allocation is maximized based on the data reception success rate.

<Data Receiver>

FIG. 10 is a configuration diagram of a data receiving block 1000 in accordance with an embodiment of the present invention. Referring to FIG. 10, the data receiving 1000 includes a transmitting unit 1002, a receiving unit 1004, and a demodulating and decoding unit 1006.

The transmitting unit 1002 transmits a data reception success rate of already received data to the data transmitter. The data transmitter may change settings for data to be transmitted, based on the data reception success rate. For example, the data transmitter may select a channel, an MCS, and so on differently based on the data reception success rate.

The receiving unit 1004 receives data through a channel selected based on the priority of data and the data reception success rate. The demodulating and decoding unit 1006 demodulates and decodes the data through a scheme corresponding to the MCS selected based on the priority of data and the data reception success rate.

The data receiver in accordance with the embodiment of the present invention may receive data transmitted so that resource allocation is maximized based on the data reception success rate.

In accordance with the embodiments of the present invention, it is possible to increase efficiency of resource utilization based on the channel states when a wireless communication system transmits/receives data. Furthermore, it is possible to guarantee a transmission/reception quality of data in a wireless communication system.

The term “block” described above is one unit indicating a device carrying out a specific function or operation. The block can be implemented by hardware, software, or a combination of the two.

The above-described devices and systems may be implemented by hardware, software, or a combination of the two. In the hardware implementation, a module used for data transmission and reception may be implemented as one or more Application-Specific Integrated Circuits (ASIC), Digital Signal Processors (DSP), Digital Signal Processing Devices (PSPD), Programmable Logic Devices (PLD), Field-Programmable Gate Arrays (AFGA), processors, controllers, micro-controllers, microprocessors, other electronic units designed to carry out the functions described herein, or a combination thereof. The software may be implemented by a module carrying out the functions described herein. Software codes may be stored in memory units and executed by a processor. The memory units may be implemented inside or outside the processor. In this case, the memory units may be connected to the processor through various known devices.

The above-described methods can also be embodied as computer programs. Codes and code segments constituting the programs may be easily construed by computer programmers skilled in the art to which the invention pertains. Furthermore, the created programs may be stored in computer-readable recording media or data storage media and may be read out and executed by the computers. Examples of the computer-readable recording media include any computer-readable recoding media, e.g., intangible media such as carrier waves, as well as tangible media such as CD or DVD.

While the present invention has been described with respect to the specific embodiments, it will be apparent to those skilled in the art that various changes and modifications may be made without departing from the spirit and scope of the invention as defined in the following claims.

What is claimed is:

1. A data transmission method, comprising:
deciding a priority of data;
deciding a channel priority based on a channel state;
selecting a modulation and coding scheme (MCS) for the data based on the priority of data;
selecting a transmission channel through which the data is to be transmitted, based on the channel priority; and
modulating and coding the data in accordance with the selected MCS, and transmitting the modulated and coded data through the selected transmission channel.

2. The data transmission method of claim 1, wherein the priority of data is decided based on types of the data.

3. The data transmission method of claim 2, wherein the types of the data comprises one or more of common data commonly transmitted to a plurality of terminals, control data containing control information, and retransmitted data.

4. The data transmission method of claim 1, wherein the channel priority is decided based on data reception success rate of a terminal.

5. The data transmission method of claim 1, wherein the channel priority is decided based on data reception sensitivity of a terminal to the channels.

6. The data transmission method of claim 1, wherein the modulation and coding scheme (MCS) for the data is selected based on the priority and the channel priority.

7. The data transmission method of claim 1, wherein the transmission channel through which the data is to be transmitted is selected based on the priority of data and the channel priority.

8. The data transmission method of claim 1, wherein the transmission channel comprises an antenna through which the data is to be transmitted.

9. A data transmitter, comprising:
a priority decision unit configured to decide a priority of data;
an MCS selection unit configured to select an MCS for the data, based on the priority of data;
a channel priority decision unit configured to decide a channel priority, based on a channel state;
a channel selection unit configured to select a transmission channel through which the data is to be transmitted, based on the channel priority; and
a data transmission unit configured to modulate and code the data in accordance with the selected MCS, and transmit the modulated and coded data through the selected transmission channel.

10. The data transmitter of claim 9, wherein the priority decision unit decides the priority of data, based on types of the data.

11. The data transmitter of claim 10, wherein the types of the data comprise one or more of common data commonly transmitted to a plurality of terminals, control data comprising control information, and retransmitted data.

12. The data transmitter of claim 9, wherein the channel priority decision unit decides the channel priority, based on a data reception success rate of a terminal.

13. The data transmitter of claim 9, wherein the channel priority decision unit decides the channel priority, based on data reception sensitivity of a terminal to the channels.

14. The data transmitter of claim 9, wherein the MCS selection unit selects an MCS for the data based on the priority and the channel priorities.

15. The data transmitter of claim 9, wherein the channel selection unit selects a transmission channel through which the data is to be transmitted, based on the priority of data and the channel priority.

16. The data transmitter of claim 9, wherein the transmission channel comprises an antenna through which the data is to be transmitted.

17. A data reception method, comprising:
transmitting state information of channels;
receiving data through a channel selected based on a priority of data and the state information; and
demodulating and decoding the data through a demodulating and decoding scheme corresponding to an MCS selected based on the priority of data and the state information.

18. The data reception method of claim 17, wherein the priority is decided based on types of the data.

19. A data receiver, comprising:
a transmission unit configured to transmit state information of channels;
a reception unit configured to receive data through a channel selected based on the priority of data and the state information; and
a demodulation and decoding unit configured to demodulate and decode the data through a demodulating and decoding scheme corresponding to an MCS selected based on the priority of data and the state information.

20. The data receiver of claim 19, wherein the priority is decided based on types of the data.
